(19) United States
(12) Patent Application Publication
(10) Pub. No.: US 2011/0276834 A1
(43) Pub. Date: Nov. 10, 2011

(54) TECHNIQUES FOR TESTING COMPUTER READABLE CODE

(75) Inventors: Patrick Calahan, San Francisco, CA (US); Miguel Canizares, San Francisco, CA (US); Venkadeshkumar Dhandapani, San Francisco, CA (US)

(73) Assignee: salesforce.com, inc., San Francisco, CA (US)

(21) Appl. No.: 12/954,556

(22) Filed: Nov. 24, 2010

Related U.S. Application Data
(60) Provisional application No. 61/331,926, filed on May 6, 2010.

(51) Int. Cl. G06F 11/36

(52) U.S. Cl. 714/38.1; 714/E11.207

(57) ABSTRACT

The present invention is directed to methods and systems of testing computer-readable code. The method includes executing a first testing module in a computer browser; launching a second testing module in the computer browser under control of the first testing module; locating an executable portion of a web-based application with the first testing module and ascertaining operational characteristics of the executable portion with the second testing module; and producing test results from the operational characteristics.

### CROSS REFERENCE TO RELATED APPLICATIONS

The present application claims priority to U.S. provisional patent application No. 61/331,926 entitled TECHNIQUES FOR INTEGRATING WEB-APPLICATIONS WITH A WEB CLIENT and identifying Patrick Calahan, Miguel Canizares and Venkadeshkumar Dhandapani as inventors.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Web-based applications typically use a web browser to support execution. These web-based applications are required to be tested against their specified functionalities in order to verify that execution will proceed as intended. For large web-based applications that have many lines of code, automated testing is preferable, because automated testing saves substantial labor as compared to manual testing.

One example of an automated testing system is available under the trade name Selenium. Selenium is a portable software testing framework for web applications that provides a record/playback tool for authoring tests without learning a test scripting language. Selenium provides a test domain specific language (DSL) to write tests in a number of popular programming languages, including C#, Java, Ruby, Groovy, Python, PHP, and Pert. Test playback is possible in most modern web browsers. Selenium deploys on Windows, Linux, and Macintosh platforms. Selenium is open source software released under the Apache 2.0 license and can be downloaded and used without charge.

A drawback with Selenium, however, is its incompatibility with flash-based programs, which use ActionScript. ActionScript is a scripting language developed by Adobe that is used primarily for the development of websites and software targeting the Adobe Flash Player platform, used on web pages in the form of embedded SWF files. As a result, testing systems have been developed that facilitate the testing of web-based applications using ActionScript. An example of one of these testing systems is available under the trade name FlexMonkey. FlexMonkey is an open source software and can be downloaded and used without charge in a manner similar to Selenium. However, FlexMonkey is not fully compatible with existing non-Flash based testing systems that makes compatibility problematic.

A need exists, therefore, to provide techniques for automating the testing of both flash-based and non-flash based web applications using open source software.

### BRIEF SUMMARY

The present invention features methods and systems of testing computer-readable code. The method includes executing a first testing module in a computer browser; launching a second testing module in the computer browser under control of the first testing module; locating an executable portion of a web-based application with the first testing module and ascertaining operational characteristics of the executable portion with the second testing module; and producing test results from the operational characteristics.

### BRIEF DESCRIPTION OF THE DRAWINGS

FIG. 1 is a simplified plan view of a computer network in which the current invention is practiced;

FIG. 2 is a plan view showing a representative architecture in which a multi-tenant database system, shown in FIG. 1, is employed;

FIG. 3 is a plan view showing the relationship between different components of an automated testing system that is employed on the computer network shown in FIG. 1; and

FIG. 4 is a flow diagram showing the functions of the method implemented in accordance with one embodiment of the present invention.

### DETAILED DESCRIPTION

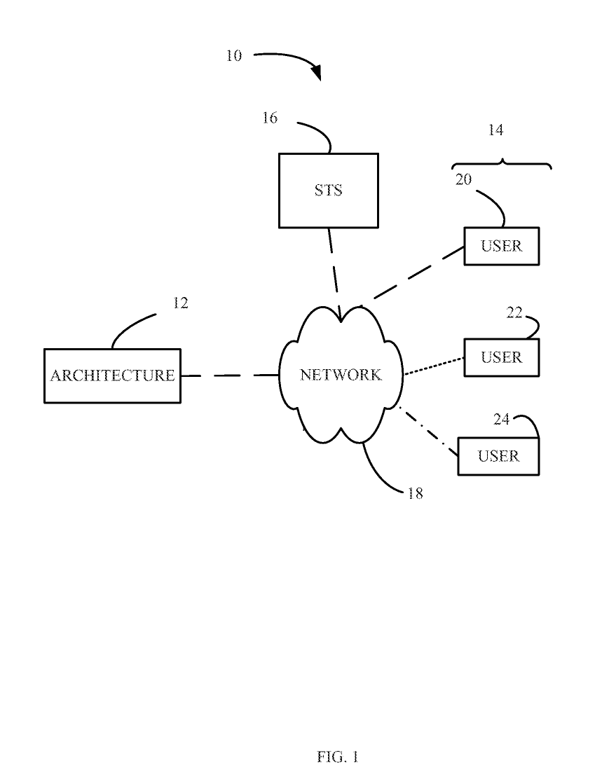

Referring to FIG. 1, a computer network 10 includes a multi-tenant database architecture 12 in data communication with client side facilities 14 and a software testing system (STS) 16. Components of computer network 10 may be in data communication over any type of known data communication network 18 or combination of networks of devices that communicate with one another. Data communication network 18 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global inter-network of networks often referred to as the “Internet” and will be used in many of the examples herein. However, it should be understood that the networks that the present invention might use are not so limited, although TCP/IP is a frequently implemented protocol. As a result the components of network 10 may be co-located in a common geographic area and/or building or spread across a diverse area of the globe, e.g., on several different continents. Typically, client side facilities 14 and STS 16 are in data communication with architecture 12 over the Internet using suitable computer systems. As a result, architecture 12 includes a multi-tenant database system (NITS) in which various elements of hardware and software are shared by one or more multiple users 20, 22 and 24 associated with client side facilities 14.

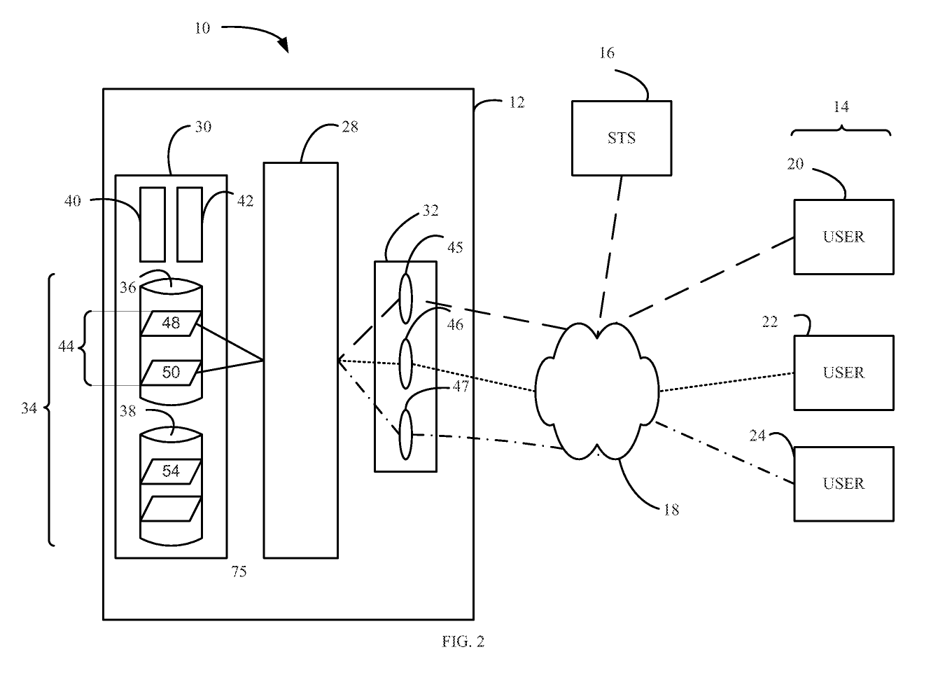

A given application server of MTS may simultaneously process requests for a great number of customers, and a given database table may store rows for a potentially much greater number of customers. To that end, and as shown in FIG. 2, architecture 12 includes a processor sub-system 28, memory space 30, in data communication therewith, and network interface resources 32 in data communication with both memory space 30 and processor sub-system 28. Processor sub-system 28 may be any known processor sub-system in the art, e.g., the CORE DUO® or the CORE 2 DUO® from Intel Corporation of Santa Clara, Calif. Memory space 30 includes drive storage 34, shown as one or more hard drives 36 and 38, as well as data and instruction registers, shown as 40, and volatile and non-volatile memory shown as 42.

Architecture 12 provides access to a database 44 by multiple users 20, 22 and 24 of client side facilities 14 over data communication network 18. To that end, network interface resources 32 include a plurality of virtual portals 45-47. Each virtual portal 45-47 provides an “instance” of a portal user interface coupled to allow access to database 44. Typically, tenants obtain rights to store information, referred to as tenant information 48 and 50, on database 44 and make the same accessible to one or more users 20, 22 and 24 to whom the tenant provides authorization. This is typically achieved by rental agreements between the tenant and an owner/provider of architecture 12. In this manner, architecture 12 provides an on-demand database service to users 20, 22 and 24 that are not necessarily concerned with building and/or maintaining the database system; rather, these functions are addressed between the tenant and the owner/provider.

With architecture 12, multiple users 20, 22 and 24 may access database 44 through a common network address, in this example a universal resource locator (URL). In response, web-pages and other content may be provided to users 20, 22 and 24 over data communications network 18. The resources of database 44 that users 20, 22 and 24 may access can be different, depending on user's 20, 22 and 24 security or permission level and/or tenant association. As a result, data structures included in tenant information is managed so as to be allocated at the tenant level, while other data structures might be managed at the user level. Because architecture 12 supports multiple tenants including possible competitors, security protocols 52 and other system software 54, stored for example on hard drive 38, maintain applications and applications' use to only those users 20, 22 and 24 with proper access rights. Also, because many tenants may desire access to architecture 12 rather than maintain their own system, redundancy, up-time, and backup are additional functions that may be implemented in architecture 12.

One advantage for a tenant utilizing architecture 12 is that functional and/or computational improvements to the same may be provided with minimal and/or no deleterious effects to a user's experience of database 44, This is achieved by testing proposed changes before releasing the same on architecture 12. To that end, changes implemented to architecture 12, including database 44, are implemented on STS 16 before being released on architecture 12. STS 16 includes hundreds of computer systems (not shown), colloquially referred to as a server farm, upon which an emulation 52 of network 10 is implemented. Emulation 52 mimics the operational interaction and operational characteristics architecture 12, client side facilities 14 and server side facilities 24. It is desired to minimize the number of man-hours required to perform the testing. Given the complexity of architecture and the number of users 20, 22 and 24 that may access the same at any given time automated test is employed. To that end, an open source testing system is employed in STS 16, One example of a test system 54 is sold under the trade name Selenium RC that is available from http://seleniumhq.org/ An instance 56 of test system 54 is run in a browser 58 of emulation 52 and used to execute a sequence of test methods 59, 60 and 61, referred to as a test group 62, on a web-based application under test, referred to as a test file 64, which is run on emulation 52. Test file 64 represents changes to architecture 12 that is desired to be implemented. Test file 64 invokes test methods 59-61 designed to locate executable portions of test file 64 and ascertain the real-time operational characteristics of architecture 12 by emulating the operation thereof with test file 64. Testing system 54 accepts commands for the browser via HTTP and is referred to as HTTP Test System (HTS) 54. HTS 54 provides a variety of client drivers to allow testing web-clients written in a myriad of languages, such as Python, Ruby, .NET, Perl, Java, JavaScript, and PHP. It is possible for HTS 54 to facilitate automated tests of a web application written in any of the aforementioned languages.

A growing number of web-applications, however, employ a multimedia platform used to add animation, video, and interactivity functionality to web pages. This is often employed to provide advertisements and games and is typically referred to as flash-technology. Flash-technology is provided by Adobe of San Jose, Calif. Flash-technology manipulates vector and raster graphics to provide animation of text, drawings, and still images. It supports bidirectional streaming of audio and video, and it can capture user input via mouse, keyboard, microphone, and camera. Flash-technology employs an object-oriented language called ActionScript. One example of a testing system for flash-based web applications, referred to herein as a flex testing system (FTS) 68 is available under the trade name Flex Monkey at http://www.gorillalogic.com/flexmonkey. While FlexMonkey works with ActionScript and Java objects, it has been problematic to integrate the testing of web pages employing flash technology with web pages that are tested employing testing systems that do not support. ActionScript.

The present invention facilitates of testing web pages employing flash technology with existing automated testing systems employed to test testing web pages not including flash technology. To that end, clients of HTS 54 are expanded to include flash communication capabilities so that javascript objects associated with HTS 54 communicate with browser 58 are used to call ActionScript functions of FTS 68. For example, using a javascript method, Flash ExternalInterface, desired specific Flash object functions may be called. The following code, for example, augments external invocation capabilities to some of the ColoredSquare Flash component methods.

// functions available for JavaScript

ExternalInterface.addCallback(“getColor”, getColor);

ExternalInterface.addCallback(“click”, changeColor);

ExternalInterface.addCallback(“getSquareLabel”, getSquareLabel);

ExternalInterface.addCallback(“setSquareLabel”, setSquareLabel);

In this manner, an HTS instance 56 and a flash object id are parameters used to control FTS 68 to test flash technology of a web application, in this case test file 64, In addition, it is possible to call flash functions in addition to that externalized by ExternalInterface method, including the default functions of any flash object, e.g., PercentLoaded( ) IsPlaying( ) and the like.

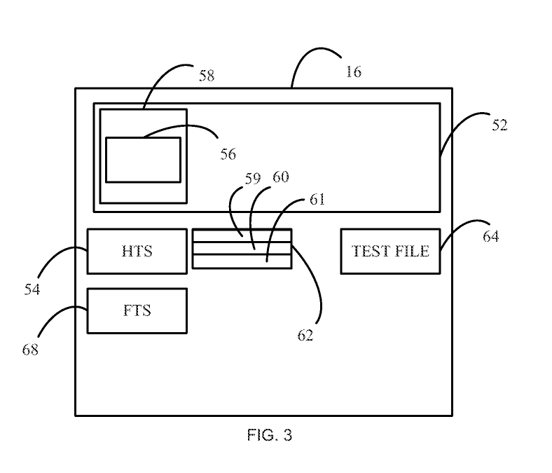

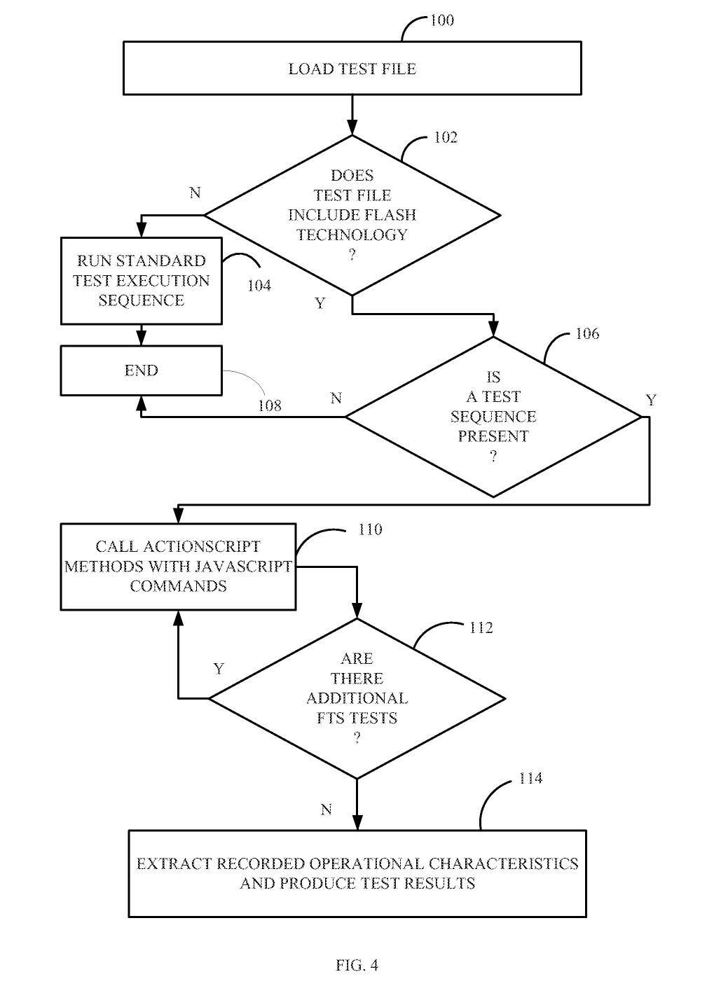

Referring to both FIGS. 3 and 4, in operation the first test module, HTS 54, loads test file 64 at function 100. Instance of HTS 56 then determines whether the test file includes flash technology at function 102, If not instance 56 proceeds to function 104 and runs a standard test execution sequence associated with web pages not including flash technology. Were it determined at function 102 that flash technology is included in the test file, then at function 106 it is determined whether a test sequence is present in FTS 68, If not the process ends at function 108. Otherwise, the process continues at function 110 at which point javascript methods associated with HTS 54 call the ActionScript methods of FTS 68. In response FTS 68 ascertains the operational characteristics of the executable portion of test file. At function 112, instance 56 determines whether there exist any additional operational characteristics to test using FTS 68. If so, function 110 is repeated. If not, the process proceeds to function 114 at which point HTS 54 extracts the recorded operational characteristics and products test result therefrom.

Computer code for operating and configuring architecture 12 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VB Script, and many other programming languages as are well known may be used. (Java™ is a trademark of Sun Microsystems, Inc.). Therefore, the scope of the appended claims should be accorded the broadest interpretation so as to encompass all such modifications and similar arrangements.

1. A method of testing computer-readable code, said method comprising:
executing a first testing module in a computer browser;
launching a second testing module under control of said first testing module;
locating an executable portion of a web-based application with said first testing module and ascertaining operational characteristics of said executable portion with said second testing module; and
producing test results from said operational characteristics.

2. The method as recited in claim 1 wherein launching further includes said first test module calling ActionScript functions associated with said second testing module using javascript.

3. The method as recited in claim 1 wherein locating further includes sequentially calling a plurality of testing functions associated with said second testing module under command of said first testing module.

4. The method as recited in claim 1 wherein launching further includes determining whether test parameters are associated with said second module for ascertaining operational characteristics of said web-based application.

5. The method as recited in claim 1 wherein launching further includes sequentially calling a plurality of testing functions associated with said second testing module under command of said first testing module and polling said second testing module with said first testing module to determine whether said sequence of tests have terminated.

6. The method as recited in claim 1 wherein locating further includes locating an executable portion of a flash-based web-based application.

7. The method as recited in claim 1 wherein locating further includes locating an executable portion of a flash-based web-based application with producing further including producing said test results with said second testing module.

8. The method as recited in claim 1 wherein locating further includes locating an executable portion of a flash-based web-based application with producing further including producing said test results with said second testing module and reporting said test results with said first testing module.

9. A computer product of the type comprising a computer readable medium that contains a program to control a computer, said computer product comprising:
computer code that executes a first testing module in a computer browser;
computer code to launch a second testing module in said computer browser under control of said first testing module;
computer code to locate an executable portion of a web-based application with said first testing module and ascertaining operational characteristics of said executable portion with said second testing module; and
computer code to produce test results from said operational characteristics.

10. The computer product as recited in claim 9 wherein the computer code to launch further includes a sub-routine to call actionscript functions associated with said second testing module using javascript associated with said first testing module.

11. The computer product as recited in claim 9 wherein the computer code to locate further includes a sub-routine to sequentially call a plurality of testing functions associated with said second testing module under command of said first testing module.

12. The computer product as recited in claim 9 wherein the computer code to launch further includes a sub-routine to determine whether test parameters are associated with said second module for ascertaining operational characteristics of said web-based application.

13. The computer product as recited in claim 9 wherein the computer code to launch further includes a first sub-routine to sequentially call a plurality of testing functions associated with said second testing module under command of said first testing module and a second sub-routine to poll said second testing module with said first testing module to determine whether said sequence of tests have terminated.

14. The computer product as recited in claim 9 wherein the computer code to locate further includes a sub-routine to locate an executable portion of a flash-based web-based application.

15. The computer product as recited in claim 9 wherein the computer code to locate further includes a sub-routine to locate an executable portion of a flash-based web-based application with said computer code to produce further including a routine to produce said test results with said second testing module.

16. The computer produce as recited in claim 9 wherein said computer code to locate further includes a sub-routine to locate an executable portion of a flash-based web-based application with said computer code to produce further including a routine to produce said test results with said second testing module and report said test results with said first testing module.

17. An apparatus for testing computer-readable code, the apparatus comprising:
a processor; and
one or more stored sequences of instructions which, when executed by the processor, cause the processor to carry out the steps of:
executing a first testing module in a computer browser;
launching a second testing module in said computer browser under control of said first testing module;
locating an executable portion of a web-based application with said first testing module and ascertaining operational characteristics of said executable portion with said second testing module; and
producing test results from said operational characteristics.

18. The apparatus as recited in claim 17 where said sequence of instructions includes additional instruction, when executed by the processor, cause the processor to carry out a step of sequentially calling a plurality of testing functions associated with said second testing module under command of said first testing module.

19. The apparatus as recited in claim 17 where said sequence of instructions includes additional instruction, when executed by the processor, cause the processor to carry out a step of determining whether test parameters are associated with said second module for ascertaining operational characteristics of said web-based application.

20. The apparatus as recited in claim 17 wherein said sequence of instructions includes additional instruction, when executed by the processor, cause the processor to carry out a step of sequentially calling a plurality of testing functions associated with said second testing module under command of said first testing module and polling said second testing module with said first testing module to determine whether said sequence of tests have terminated.
